(19) United States
(12) Patent Application Publication
(10) Pub. No.: US 2017/0319988 A1
(43) Pub. Date: Nov. 9, 2017

(54) Removal of Suspended Solids from Waste Water

(71) Applicants: Chris Taylor, Winona, TX (US); Ethan McBroom, Canyon, TX (US)

(72) Inventors: Chris Taylor, Winona, TX (US); Ethan McBroom, Canyon, TX (US)

(21) Appl. No.: 15/587,080

(22) Filed: May 4, 2017

Related U.S. Application Data
(60) Provisional application No. 62/332,833, filed on May 6, 2016.

(51) Int. Cl. B01D 21/00; C02F 1/52; B01D 21/01; B01D 25/12; C02F 1/00; C02F 1/78; C02F 1/50; C02F 1/32; E21B 43/26; C02F 101/10; C02F 101/20; C02F 101/32; C02F 103/10

(52) U.S. Cl. CPC B01D 21/0087; E21B 43/26; C02F 1/52; B01D 21/006; B01D 21/01; B01D 25/12; C02F 1/008; C02F 1/78; B01D 21/0057; C02F 1/50; C02F 1/32; C02F 2001/007; C02F 2101/101; C02F 2101/203; C02F 2101/32; C02F 2103/10

(57) ABSTRACT

A system and method for removing suspended solids from waste water includes flowing a volume of waste water through a series of flow chambers arranged between an inlet and an outlet. Each of the flow chambers includes a flow path that is substantially transverse (orthogonal) to a predominant flow path between the inlet and the outlet. The flow chambers are arranged substantially parallel to each other in a switchback (antiparallel) configuration. Stops (e.g., oil or debris stops) are disposed in one or more flow chambers. The stops are configured to substantially impede (or otherwise reduce) introduction of floating material to a flow chamber immediately downstream of each stop. Weirs are disposed in one or more of the flow chambers. The weirs are configured to substantially impede (or otherwise reduce) introduction of settled solids to a flow chamber immediately downstream of each weir.

### PRIORITY CLAIM AND RELATED APPLICATIONS

This application claims the benefit of U.S. Provisional Patent Application No. 62/332,833, filed on 6 May 2016, entitled “SYSTEM AND METHOD FOR REMOVING SUSPENDED SOLIDS FROM PRODUCED OIL FIELD WATER,” which application is hereby incorporated herein by reference in its entirety.

### TECHNICAL FIELD

The present disclosure generally relates to waste water remediation, and more particularly, to the removal of suspended solids from produced oil field water.

### BACKGROUND

Oil and gas operators use water for operations. Oil wells produce about 220 million Barrels of Water per Day (BWPD). This corresponds to approximately three barrels of water for every barrel of oil. In older fields, the “water cut” (ratio of water-to-oil) can be 95% or greater. Managing produced oil field water is a significant challenge for operators.

In North America, unconventional gas stimulation generally requires approximately 14 million BWPD to increase well productivity. Thermal Enhanced Oil Recovery (EOR) generally requires steam for improved recovery of heavy oil, and uses an additional 500,000 BWPD. Secondary recovery using water floods for conventional oil can add another million BWPD. Finding and transporting water for operations can present challenges.

The ability to reduce and recycle produced oil field water, and minimize fresh water supplementation, can improve oil field operator profitability, and promote water conservation.

### SUMMARY

A general aspect of the disclosure herein includes a system for removing suspended solids from waste water. The system includes: an inlet, an outlet, and predominant flow path from the inlet to the outlet. The system also includes a plurality of flow chambers interposed between the inlet and the outlet. Each of the plurality of flow chambers includes a flow path that is substantially transverse (orthogonal) to the predominant flow path. Each of the flow chambers of the plurality of flow chambers are arranged substantially parallel to each other. The system also includes a plurality of stops disposed in one or more of the plurality of flow chambers. The stops are configured to impede (e.g., prevent or otherwise reduce) introduction of surface borne floating material to a flow chamber immediately downstream of each respective stop. A plurality of weirs is disposed in one or more of the plurality of flow chambers. The weirs are configured to impede (e.g., prevent or otherwise reduce) introduction of settled suspended solids to a flow chamber immediately downstream of each respective weir.

Another general aspect includes a device for removing suspended solids from waste water, where the device includes an inlet and an outlet. The device also includes a plurality of flow chambers interposed between the inlet and the outlet, where each of the flow chambers are configured with a chamber flow path that is arranged substantially antiparallel (e.g., in opposite direction) to a neighboring chamber flow path of an immediately adjacent flow chamber. The flow chambers are arranged substantially parallel to each other. The device also includes a plurality of stops disposed in one or more of the plurality of flow chambers. The stops are configured to at least reduce (or otherwise impede) introduction of surface borne floating material to a flow chamber immediately downstream of each stop. A plurality of weirs is disposed in one or more of the plurality of flow chambers. The weirs are configured to at least reduce (or otherwise impede) introduction of settled suspended solids to a flow chamber immediately downstream of each weir.

Yet another general aspect includes a method of reducing suspended solid concentration in a volume of waste water. The method includes a step of introducing a volume of water to an inlet. After introducing the volume of water to the inlet, a volume of water is flowed through a plurality of flow chambers. After flowing the volume of water through the plurality of flow chambers, the volume of water is discharged from an outlet. The flow chambers are interposed between the inlet and the outlet. Each of the flow chambers includes a flow path that is substantially orthogonal (transverse) to a predominant flow path between the inlet and the outlet. Each of the plurality of flow chambers are arranged substantially parallel to each other. The flow chambers include a plurality of stops configured to impede (or otherwise reduce) introduction of surface borne floating material to a flow chamber immediately downstream of each stop, and a plurality of weirs configured to impede (or otherwise reduce) introduction of settled suspended solids to a flow chamber immediately downstream of each weir. The volume of water has a first concentration of suspended solids upon introduction to the inlet, and a second concentration of suspended solids after discharge from the outlet. The second concentration of suspended solids is less than the first concentration of suspended solids. Other embodiments of this aspect include corresponding computer systems, devices, apparatuses, and computer programs recorded on one or more non-transitory, computer-readable storage devices, each configured to perform actions (e.g., flow/process control) of the methods.

### BRIEF DESCRIPTION OF THE DRAWINGS

Representative aspects of the present disclosure may be understood from the following detailed description when read in conjunction with the accompanying Figures. It is noted that, in accordance with standard practice in industry, various features may not be drawn to scale. For example, dimensions of various features may be arbitrarily increased or reduced for clarity of illustration or description. Corresponding numerals and symbols in different Figures generally refer to corresponding parts, unless otherwise indicated.

FIG. 1 illustrates a plan view of a system for removing suspended solids from produced water, in accordance with a representative embodiment.

FIG. 2 representatively illustrates a cross section view of the system illustrated in FIG. 1 along the 2-2 Cross section.

FIG. 3 representatively illustrates a cross section view of a portion of the system illustrated in FIG. 1 along the 3-3 cross section.

FIG. 4 illustrates a diagram of a system for removing suspended solids from produced water, in accordance with a representative embodiment.

FIG. 5 illustrates a plan view of system for removing suspended solids from waste water, in accordance with a representative embodiment.

FIG. 5A representatively illustrates a cross section view of the system illustrated in FIG. 5 along the A-A cross section.

FIG. 5B representatively illustrates a cross section view of the system illustrated in FIG. 5 along the B-B cross section.

FIG. 5C representatively illustrates a cross section view of the system illustrated in FIG. 5 along the C-C cross section.

FIG. 6 illustrates a representative method of reducing suspend solid concentration in waste water, in accordance with an embodiment.

### DETAILED DESCRIPTION

Representative embodiments are discussed in detail herein. It should be appreciated, however, that concepts disclosed herein may be embodied in a variety of contexts, and that specific embodiments discussed herein are merely illustrative and are not intended to limit the scope of the claims. Furthermore, various changes, substitutions, and alterations can be made herein without departing from the spirit and scope as defined by the appended claims.

Conventional systems for removing suspended solids are generally not well-suited for processing large volumes of produced water generated from oil field operations (e.g., fracking). Representative embodiments will be described with respect to a specific context; namely, a system and method for treating large volumes of oil field produced water for disposal, reclamation, or reuse while satisfying a broad range of reservoir management and environmental protection objectives. Persons skilled in the art will appreciate that representatively disclosed features may be suitably adapted, or otherwise configured, to improve waste water treatment for disposal, reclamation, recycling, reuse, or reduction of fresh water use in a variety of other context (g, commercial or municipal waste water treatment and processing, or the like).

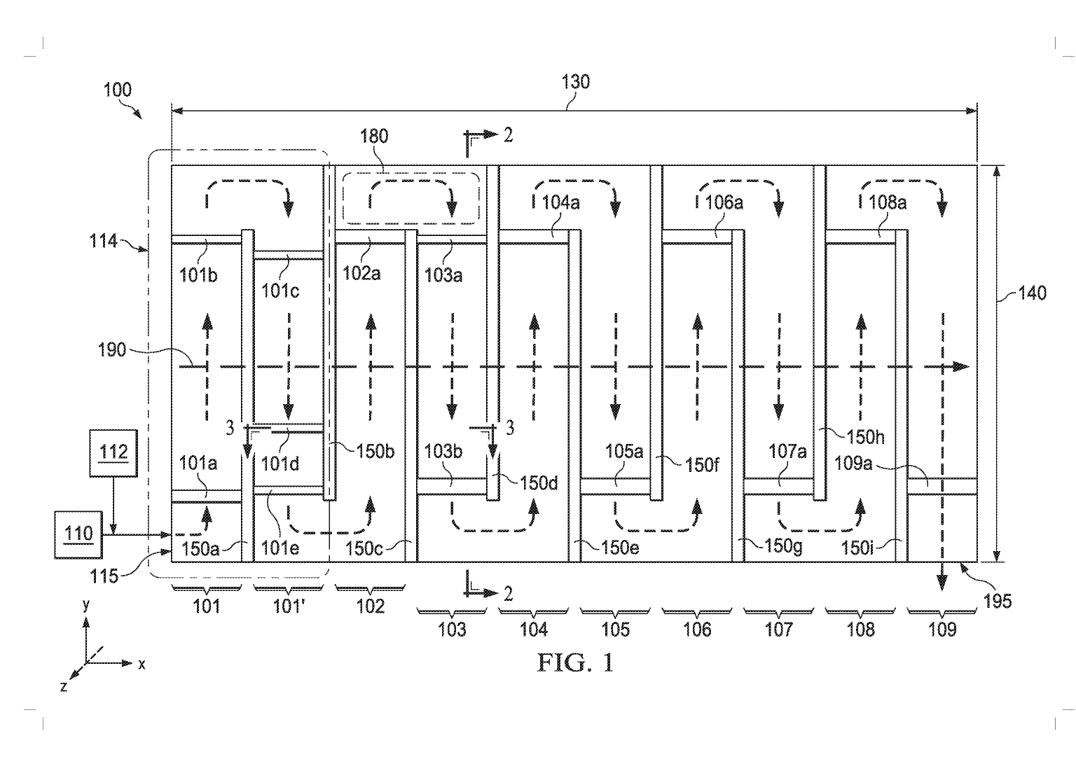

As representatively illustrated in FIG. 1, a representative system 100 for produced water 110 treatment comprises nine flow chambers (101 and 101′, 102, 103, 104, 105, 106, 107, 108, 109) arranged in a switchback flow path, in accordance with an embodiment. Produced water 110 may be optionally treated with biocide 112 to prevent bacterial growth or to reduce hydrogen sulfide that may result from, e.g., prokaryotic breakdown of organic matter in produced water 110. Biocide 112 may comprise one or more of sodium hypochlorite, chlorine, chlorine dioxide, calcium hypochlorite, bromine, hydrogen peroxide, silver, hypobromous acid, sodium bromide, ozone, chloroisocyanurates, ultraviolet (UV) radiation, or the like. Alternatively, conjunctively, or sequentially, salt water produced from system 100 may be re-introduced to biocide 112 as feedstock to generate sodium hypochlorite, provided that the salt concentration of produced water 110 is sufficient.

In a representative embodiment, chamber dividing walls 150a, 150b, 150c, 150d, 150e, 150f, 150g, 150h, 150i and perimeter walls of system 100 may be formed from field soil at or in the vicinity of oil field operation. In a representative embodiment, perimeter walls 130 along the longest dimension of system 100 may be about 590 feet, and perimeter walls 140 along the shortest dimension of system 100 may be about 300 feet. It will be appreciated, however, that various other dimensions and ratios of perimeter dimensions (e.g., length-to-width) may be alternatively used to produce substantially similar results. For example, a ratio of perimeter wall dimension 130 to perimeter wall dimension 140 may be about 2.1:1, or about 2.0:1, or about 1.9666:1. In various other embodiments, a ratio of perimeter wall dimension 130 to perimeter wall dimension 140 may be greater than or equal to about 2. In still other embodiments, a ratio of perimeter wall dimension 130 to perimeter wall dimension 140 may be less than or equal to about 1.9. In general, the larger the scalar dimensions of the perimeter walls, the greater the volume of produced water 110 that can be accommodated or processed by system 100. In a representative embodiment with perimeter wall dimensions 130, 140 of 590 feet by 300 feet respectively, system 100 may be suitably configured (or otherwise adapted) to process approximately 370,000 barrels of produced water 110 in a given unit processing cycle. It will be further appreciated that system 100 may alternatively or conjunctively comprise various other shapes in a plan view, including, e.g., a circle, a triangle, a rhombus, an orthorhomboid (as representatively illustrated in FIG. 1), or regular or irregular polygons of higher order, or the like. Fabrication of system structures from soil located at the construction site provides substantial cost savings as compared with conventional alternatives.

In a representative embodiment, system 100 may be fabricated at or near an oil field operation location with excavation and topographic shaping of soil in the field. Containment surfaces of system 100 configured to retain produced water 110 during processing may be lined with, e.g., polyethylene sheeting, or similar lining material. In an embodiment, a 40 mil polyethylene sheet may be rolled out over a containment surface of system 110 and welded to another 40 mil polyethylene sheet. Iterative roll out and welding of polyethylene sheets may proceed until all, or a substantial fraction or suitable portion of, containment surfaces are covered with polyethylene sheeting. Welding may be performed by thermal or ultrasonic fusion of seams for adhering or otherwise adjoining plastic sheets.

In accordance with a representative embodiment, a 0.5 inch felt liner may be placed over the welded polyethylene sheeting. The felt liner may be configured with one or more leak detection sensors disposed on or within the felt liner. In a representative embodiment, the leak detection sensor(s) may comprise a 200 mil geosynthetic hyper-net×450,000 ft² electronic leak detector. Thereafter, a second 40 mil polyethylene sheet may be rolled out over the felt liner and sensor(s). The second polyethylene sheet may be welded to additional polyethylene sheets with iterative roll out and welding to cover all, or a substantial fraction or suitable portion of, the underlying felt liner, sensor(s), or first polyethylene sheeting. It will be appreciated that various other materials may be used in place of polyethylene sheets, including, e.g., 40 mil linear low-density polyethylene (LLDPE) plastic×430,000 ft², 60 mil high-density polyethylene (HDPE) plastic×430,000 ft², or the like. It will be further appreciated that various other materials may be used in place of felt lining. Accordingly, representative embodiments of system 100 may comprise a double-lined containment structure with integrated leak detection.

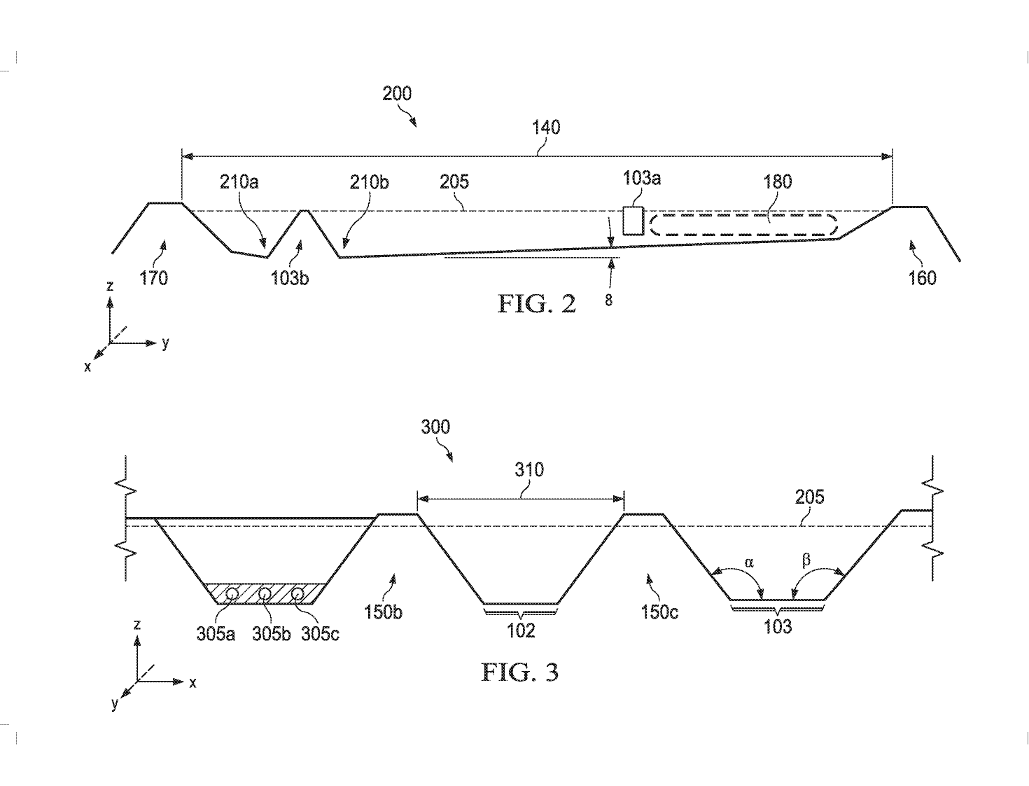

After optional treatment with biocide 112, input produced water 110 is introduced (flowed, fed, pumped, or the like) to first flow chamber lot, 101′ where input produced water 110 encounters first oil stop 101a. First oil stop 101a is configured to prevent (or otherwise impede or substantially reduce) the flow of produced water 110 along an upper surface portion of produced water 110 while permitting flow of produced water 110 under first oil stop 101a (see, e.g., fifth oil stop 103a in FIG. 2). Oil and other materials having a density less than that of produced water 110 will generally float on the surface of produced water 110 and, therefore, be impeded (e.g., impaired or otherwise stopped) from flowing into downstream adjoining chambers (e.g., 102) or chamber portions (e.g., of 101, or 101′).

As produced water 110 proceeds to flow under first oil stop 101a into the next adjoining chamber portion, produced water 110 encounters second oil stop 101b. Second oil stop has a substantially similar configuration as that of first oil stop 101a and fifth oil stop 103a. In similar fashion, second oil stop 101b impedes less dense materials (e.g., surface borne floating materials) from being introduced into downstream adjoining chambers or chamber portions.

In accordance with a representative embodiment, as produced water 110 proceeds to flow under second oil stop 101b into the next adjoining chamber portion, the direction of produced water 110 flow is redirected (e.g., by 180°). The redirection of produced water 110 flow may comprise a switchback configuration such that water flowing in chamber portion 101′ is antiparallel (e.g., in a direction opposite) to direction of water flow in chamber portion 101. After the flow has been redirected, produced water 110 encounters third oil stop 101c. Third oil stop 101c has a substantially similar configuration as that of first oil stop 101a, second oil stop 101b, and fifth oil stop 103a. In similar fashion, third oil stop 101c impedes less dense (floating) materials from being introduced into downstream adjoining chambers or chamber portions.

As produced water 110 proceeds to flow under third oil stop 101c into the next adjoining chamber portion, produced water 110 encounters fourth oil stop 101d. Fourth oil stop 101d has a substantially similar configuration as that of first oil stop 101a, second oil stop 101b, third oil stop 101c, and fifth oil stop 103a. In similar fashion, fourth oil stop 101d impedes less dense (floating) materials from being introduced into downstream adjoining chambers or chamber portions.

As produced water 110 proceeds to flow under fourth oil stop 101d into the next adjoining chamber portion, produced water 110 encounters first bottom weir 101e. First bottom weir 101e is configured to permit produced water 110 to spill over an upper surface of first bottom weir 101e into the next adjoining chamber portion. As produced water 110 spills over first bottom weir 101e, suspended solids with a density greater than that of produce water 110 will gravimetrically settle along lower portions of first bottom weir 101e. As will be described later herein, settled suspended solids may be removed from system 100 with, e.g., a hydraulic vacuum apparatus.

In accordance with an embodiment, first flow chamber 101, 101′ may be covered with covering 114 to substantially (or at least suitably) block ambient UV exposure from the environment in order to prevent degradation of trapped oil that may be skimmed and subsequently sold as a byproduct of produced water 110 processing. In a representative embodiment, first flow chamber 101, 101′ may be covered with a photovoltaic (e.g., solar cell) array to power various equipment (e.g., pumps, valves, controls, or the like) to further reduce operating costs of system 100. In another representative aspect, covering 114 may be configured to trap rain water, which may be captured and used in processing by system 100.

In accordance with a representative embodiment, an oil skimmer may be placed in first flow chamber 101, 101′ to remove floating oil from system 100 (e.g., with hydrophobic belts).

As produced water 110 proceeds to spill over first bottom weir 101e into the next adjoining chamber portion, produced water 110 flow is redirected (e.g., switched back 180°) out of first flow chamber 101, 101′ for introduction into second flow chamber 102. Produced water 110 flows along second flow chamber 102 disposed between chamber dividing walls 150b, 150c where the flow subsequently encounters second bottom weir 102a. Second bottom weir 102a has a substantially similar configuration as that of first bottom weir 101e and third bottom weir 103b (as representatively illustrated in FIG. 2). In similar fashion, second bottom weir 102a is configured to permit produced water 110 to spill over an upper surface portion of second bottom weir 102a into the next adjoining chamber portion. As produced water 110 spills over second bottom weir 102a, suspended solids with a density greater than that of produce water 110 will gravimetrically settle along lower portions of second bottom weir 102a (e.g., for later removal from system 100 with a hydraulic vacuum apparatus). The next adjoining chamber portion may optionally comprise a mixing apparatus 180 for introduction and mixing of a flocculant. Flocculant may be optionally added and mixed with produced water 110 to aid gravimetric settling of suspend solids by causing suspended solids to fall out of suspension. In accordance with various representative embodiments, a flocculant may comprise one or more of aluminum chloride, alum, aluminum sulfate, calcium oxide, calcium hydrochloride, iron sulfate, iron chloride, polyacrylamide, polydiallyldimethylammonium chloride (polyDADMAC), sodium aluminate, sodium silicate, chitosan, isinglass, gelatin, strychnos (Loganiaceae Stychnos), guar gum, alginate, or the like. The amount of flocculant used may be suitably adapted to configure a resonance time of system 100.

As produced water 110 proceeds to flow through optional flocculant mixing region 180 into the next adjoining chamber portion (e.g., flow chamber 103), produced water 110 encounters fifth oil stop 103a. In similar fashion to produced water 110 flow at preceding oil stops, fifth oil stop 103a impedes less dense (floating) materials from being introduced into downstream adjoining chambers or chamber portions. Produced water 110 flows along third flow chamber 103 disposed between chamber dividing walls 150c, 150d where it subsequently encounters third bottom weir 103b. FIG. 2 representatively illustrates a cross section (along the 2-2 cross section of FIG. 1) of first perimeter wall 170, third bottom weir 103b, fifth oil stop 103a, and second perimeter wall 160. First and second perimeter walls 160, 170 may have a sloped configuration, e.g., to aid aggregation of settled suspended solids, similar to the sloped configuration of third bottom weir 103b. Moreover, in a representative embodiment, a floor portion of flow chamber 103 may be graded to aid in the aggregation of settled suspended solids toward lower lying bottom portion of third bottom weir 103b. In a representative embodiment, an angle γ of grading for a floor portion of flow chamber 103 may be about 2.5°. In alternative embodiments angle γ of grading for floor portion of flow chamber 103 may be between about 1° and about 15°. Flow chambers 101/101′, 102, 104, 105, 106, 107, 108, or 109 may be similarly graded. A hydraulic vacuum apparatus (not illustrated) may be used to apply suction to lower regions of bottom weirs (e.g., third bottom weir 103b, as shown in FIG. 2) to remove settled suspended solids (e.g., sludge) from system 100. Settling times may be suitably configured (or otherwise adapted) by controlling an amount of flocculant and a flow rate of produced water 110 in system 100.

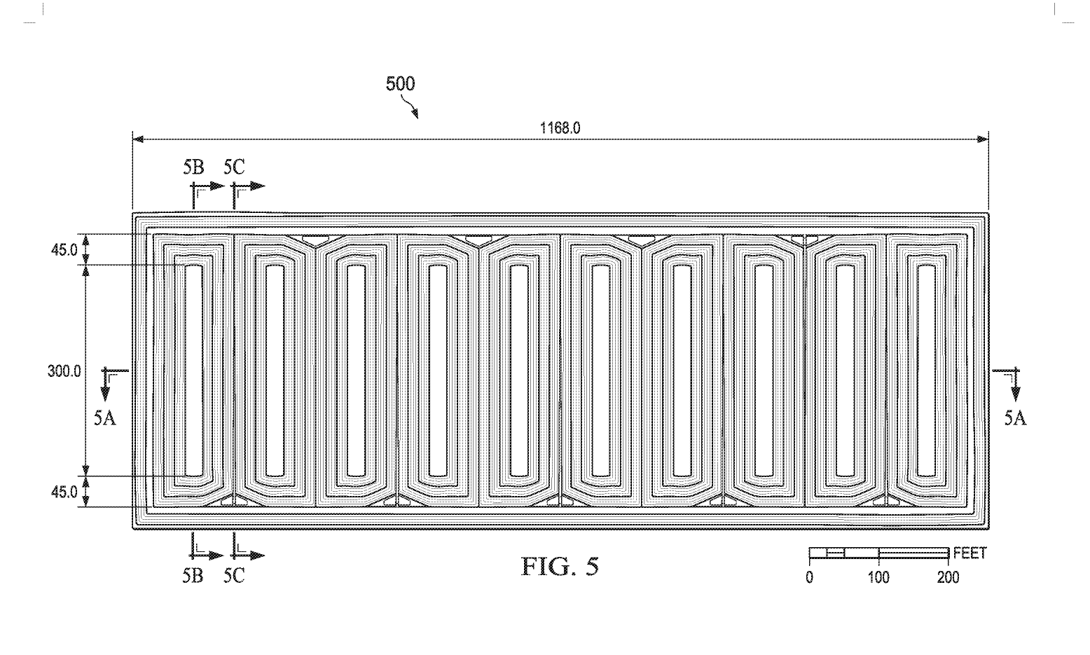

Settled material may be pumped off bottom surfaces of system 100 and run through a filter press 460 (as representatively illustrated in FIG. 4). Once filter press 460 is full, filter elements of filter press 460 may be scraped or blown out to liberate dry pack waste that may be disposed of or otherwise prepared for sale. Dry packing of solid waste substantially reduces disposal costs attendant with reduction of total volume provided for disposal, sale, or subsequent disposition.

Produce water 110 spills over third bottom weir 103b and is redirected (switched back) by 180° to flow through fourth flow chamber 104. Flow chamber 104, 105, 106, 107, and 108 are similarly configured (in switchback fashion) with bottom weirs 104a, 105a, 106a, 107a, and 108a, respectively. Debris stop 109a is provided to trap any floating material that might otherwise be discharged to outlet 120 (in similar fashion to oil stops 101a, 101b, 101c, 101d, and 103a). The configuration or arrangement of oil stops, bottom weirs, and debris stop is substantially transverse to the flow of produced water 110 in the respective flow chambers. The flow of produced water 110 in respective flow chambers is substantially transverse to predominant direction of fluid flow 190 from inlet 115 to outlet 195 of system 100.

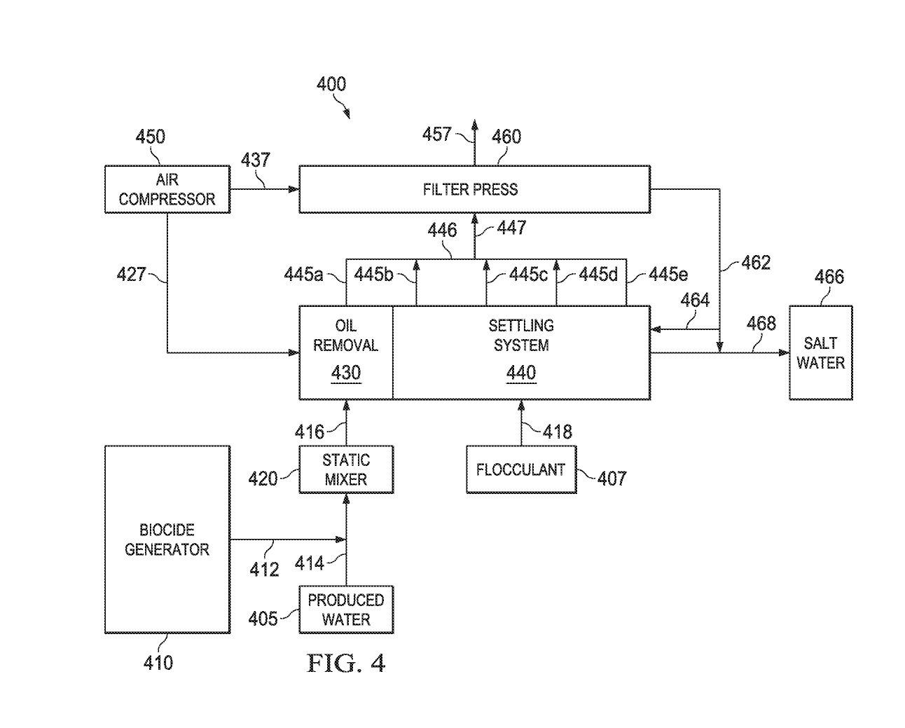

FIG. 3 representatively illustrates a cross section taken through fourth oil stop 101d, second flow chamber 102, and third flow chamber 103 in a direction orthogonal to both the plan view of FIG. 1 and the cross section view of FIG. 2. As representatively illustrated in FIG. 3, flow chambers may be configured with tapered sidewalls having taper angles α, β. In accordance with representative aspects, α may be the same as or different than β.

As representatively illustrated in FIG. 4, oil removal section 430 of system 400 generally corresponds to first flow chamber 101, 101′ of system 100, as generally illustrated in FIG. 1. Settling system 440 generally corresponds to flow chambers 102, 103, 104, 105, 106, 107, 108, and 109. Flocculant 407 may be provided to system 100 via flocculant flow line 418. Produced water 405 (110, FIG. 1) may be provided to system 100 via produced water flow line 414. Biocide 112 may be provided from biocide generator 410 to produced water 405 (110) through biocide flow line 412. A combination of produced water 405 and biocide 112 may be provided to static mixer 42 for mixing. Thereafter, mixed produced water 405 and biocide 112 may be provided to oil removal section 430 through input flow line 416. Air compressor 450 may be configured to provide air through micro-bubbler supply flow line 427 to bubble air in oil removal section 430. A suction manifold 446 comprising vacuum flow lines 445a, 445b, 445c, 445d, 445e may be provided for vacuum removal of settled suspended solids in the vicinity of lower lying portions of bottom weirs 101e, 102a, 103b, 104a, 105a, 106a, 107a, 108a. Settled suspended solids (e.g., sludge) may be provided to filter press 460 through vacuum flow line 447. Dry packed waste may be removed from filter press 460 to roll off boxes at 457. Air compressor 450 may also have an air supply flow line 437 to filter press 460 to aid removal of dry packed waste from filter elements of filter press 460. Expressed water from filter press 460 may be flowed through filter water flow line 462 to a return flow line 464 for reintroduction to settling system 440, or mixed with output water from settling system 440 through output flow line 468. In a representative embodiment, output water from settling system 440 may comprise salt water 466.

In accordance with a representative embodiment, flow of produced water 110 from inlet 115 of first flow chamber portion 101 to the outlet 195 is substantially continuous. That is to say, in representative embodiments, system too provides a substantially continuous method and processing apparatus for removing suspended solids from produced water 110. Processed produced water 110 exiting outlet 195 is substantially cleaner than produced water 110 provided to inlet 155 of first flow chamber portion 101. As used herein, the term “cleaner” may be generally understood to mean as having at least one of a lower oil concentration or a lower concentration of suspended solids.

System too may comprise a portable or mobile unit for removing suspended solids from produced water. Input produced water may be substantially more optically opaque (i.e., “dirtier”) than the “cleaned” output water.

In a representative embodiment, oil stops 101a, 101b, 101c, 101d, 103a or debris stop 109a may be fabricated from a polymer material suitable for use with salt water at ambient temperatures. In an embodiment, stops 101a, 101b, 1010c, 101d, 103a, 109a may comprise polymer pipe buried in soil with attachment of polymer liner to the polymer pipe.

In a representative embodiment, ancillary flow lines may be fabricated from a polymer material suitable for use with salt water at ambient temperatures, e.g., low-density polyethylene (LDPE), high-density polyethylene (HDPE), polyvinylchloride (PVC), acrylonitrile butadiene styrene (ABS), chlorinated PVC (CPVC), polypropylene (PP), polybutylene (PB), polyvinylidene fluoride (PVDF), cross-linked polyethylene (PEX), polyamide 11 (PA11), polyketone (PK), or the like.

In accordance with another representative embodiment, system 100 may comprise a mobile unit that may be, e.g., skid mounted. A plurality of skid mounted units may be ganged together to increase processing volume.

In accordance with representative embodiments, system 100 may be adapted to replace disposal wells with recycled water than can be used in fracking operations, thereby reducing occasioning of fresh water use in oil field operations. In accordance with another representative aspect, system too may be adapted to address issues related to earthquakes or localized shifts in ground topography caused by water disposal wells in oil field operations. In accordance with yet another representative aspect, system too may be adapted to reduce the need for fresh water supplementation in oil field fracking operations. In accordance with still another representative aspect, system 100 provides a cost effective alternative to conventional cleaning methods. In accordance with a further representative aspect, construction of system 100 from existing field soil substantially reduces costs. In accordance with another representative aspect, the use of a photovoltaic array covering flow chamber 101, 101′ may provide a “green” or otherwise environmentally friendly system.

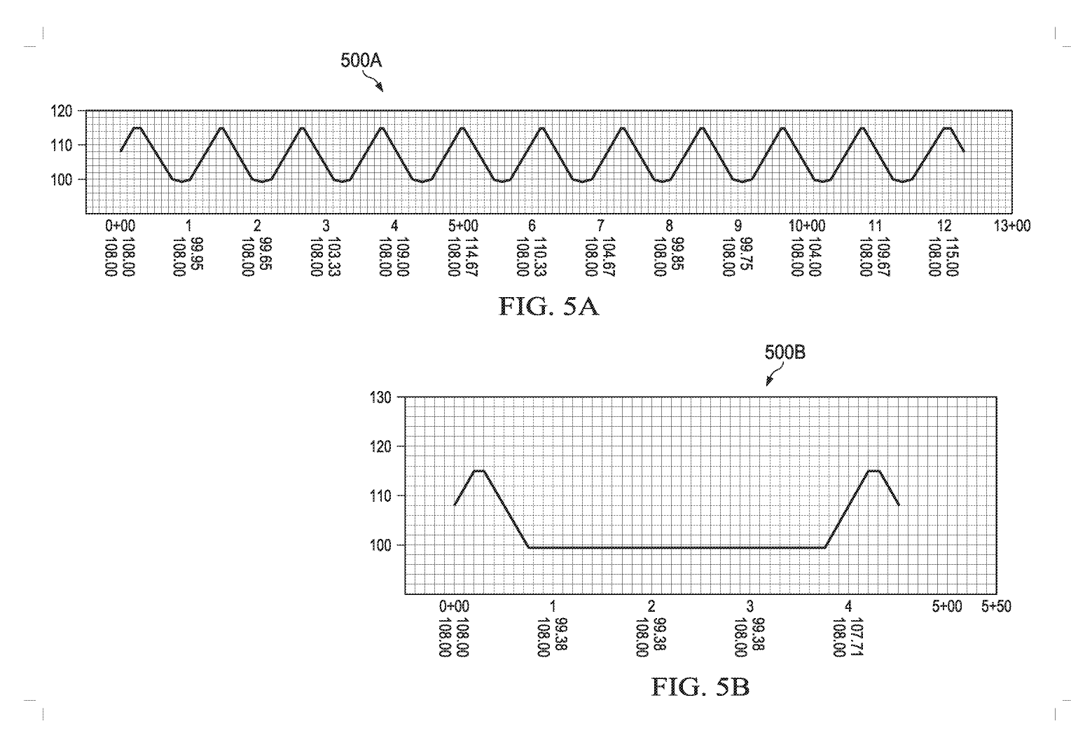

A system 500 for removing suspended solids in waste water may be configured with flow chambers having shapes and dimensions as representatively illustrated in FIG. 5. Cross section 500A is taken along the A-A cross section of FIG. 5, as generally illustrated with representative dimensions in FIG. 5A. Cross section 500B is taken along the B-B cross section of FIG. 5, as generally illustrated with representative dimensions in FIG. 5B. Cross section 500C is taken along the C-C cross section of FIG. 5, as generally illustrated with representative dimensions in FIG. 5C. As noted above, any of the representative dimensions in FIG. 5, 5A, 5B, or 5C may be variously modified in alternative embodiments.

A SEDCAD 4 model was constructed for evaluation. In a representative implementation, a treatment pond consisting of seven substantially identical 300-foot-long trapezoidal-shaped chambers was configured with trapezoidal weirs connecting each of the chambers. Each chamber was configured to hold 54,000 BBL of water. Sediment-laden water was pumped to the first chamber at a rate of 50,000 barrels per day. When the first chamber became full, water flowed through a weir into the second chamber. When the second chamber became full, water flowed through a weir into the third chamber, and so on until all seven chambers were filled. Water entering each successive chamber had less suspended solids than that of water in the immediately preceding chamber. Water in the final chamber was relatively free of suspended solids, and was made available for reuse. The first chamber had a skimmer to remove oil floating on the surface. The first chamber was covered with a tarp in order to prevent birds from landing on the water. Each chamber was lined with a leak-detecting HDPE liner. Sediment from each chamber was removed through a perforated pipe in the bottom of each chamber. When sediment reached a determined level, pumps were activated to remove sediment through the perforated pipes.

Total suspended solids were reduced from about 120 ppm in a raw input sample to less than about 5 ppm in a cleaned sample, in accordance with representative embodiments disclosed herein. Total dissolved solids were reduced from about 217,000 ppm in a raw input sample to about 213,000 ppm in a cleaned sample, in accordance with representative embodiments disclosed herein. Iron oxide was reduced from about 91.5 ppm in a raw input sample to a non-detectable amount in a cleaned sample. Calcium carbonate was reduced from about 14.2 ppm in a raw input sample to a non-detectable amount in a cleaned sample. Barium sulfate was reduced from about 1.2 ppm in a raw input sample to a non-detectable amount in a cleaned sample. Strontium sulfate was reduced from about 1.0 ppm in a raw input sample to a non-detectable amount in a cleaned sample.

In another representative implementation, total suspended solids were reduced from about 480 ppm in a raw input sample to less than about 5 ppm in a cleaned sample. Iron oxide was reduced from about 297.1 ppm in a raw input sample to about 0.68 ppm in a cleaned sample. Calcium carbonate was reduced from about 107.0 ppm in a raw input sample to about 0.31 ppm in a cleaned sample. Barium sulfate was reduced from about 48.5 ppm in a raw input sample to a non-detectable amount in a cleaned sample. Strontium sulfate was reduced from about 27.5 ppm in a raw input sample to a non-detectable amount in a cleaned sample.

In an embodiment, a system for removing suspended solids from waste water includes: an inlet; an outlet; a predominant flow path from the inlet to the outlet; a plurality of flow chambers interposed between the inlet and the outlet, wherein each of the plurality of flow chambers includes a flow path that is transverse to the predominant flow path, and each of the flow chambers of the plurality of flow chambers are arranged substantially parallel to each other; a plurality of stops disposed in one or more of the plurality of flow chambers, the plurality of stops suitably configured (or otherwise adapted) to impede introduction of surface borne floating material to a flow chamber immediately downstream of each stop; and a plurality of weirs disposed in one or more of the plurality of flow chambers, the plurality of weirs suitably configured (or otherwise adapted) to impede introduction of settled suspended solids to a flow chamber immediately downstream of each weir. The plurality of stops may include a plurality of oil stops. The plurality of stops may include one or more debris stops. Each of the plurality of weirs may be suitably configured (or otherwise adapted) to allow a top portion of flowing fluid to spill over an upper portion of respective ones of the plurality of weirs. The plurality of flow chambers may include a switchback configuration. The switchback configuration may include an anti-parallel flow direction as between immediately adjacent flow chambers. The system may be suitably configured (or otherwise adapted) to progressively reduce suspended solid concentration along the predominant flow path. Each flow chamber may include at least one of at least one stop, or a weir. At least one flow chamber of the plurality of flow chambers may include a plurality of stops, and a weir. At least another flow chamber of the plurality of flow chambers may include a stop and a weir, and the at least another flow chamber may be downstream from the at least one flow chamber.

In another embodiment, a device for removing suspended solids from waste water includes: an inlet; an outlet; a plurality of flow chambers interposed between the inlet and the outlet, wherein each of the plurality of flow chambers is suitably configured (or otherwise adapted) with a chamber flow path that is arranged antiparallel to a neighboring chamber flow path of an immediately adjacent flow chamber, and the plurality of flow chambers are arranged substantially parallel to each other; a plurality of stops disposed in one or more of the plurality of flow chambers, the plurality of stops suitably configured (or otherwise adapted) to at least reduce introduction of surface borne floating material to a flow chamber immediately downstream of each stop; and a plurality of weirs disposed in one or more of the plurality of flow chambers, the plurality of weirs suitably configured (or otherwise adapted) to at least reduce introduction of settled suspended solids to a flow chamber immediately downstream of each weir. The plurality of stops may include a plurality of oil stops, and one or more debris stops. Each of the plurality of weirs may be suitably configured (or otherwise adapted) to allow a top portion of fluid flow to spill over an upper portion of respective ones of the plurality of weirs. Each of the plurality of flow chambers may be arranged in a switchback configuration relative to immediately neighboring flow chambers. The device may be suitably configured (or otherwise adapted) to progressively reduce suspended solid concentration of a volume of waste water introduced to the inlet as the volume of waste water flows from the inlet to the outlet. Each flow chamber may include at least one of a stop or a weir. At least one flow chamber of the plurality of flow chambers may include a plurality of stops, and a weir. At least another flow chamber of the plurality of flow chambers may include a stop and a weir, and the at least another flow chamber is downstream from the at least one flow chamber.

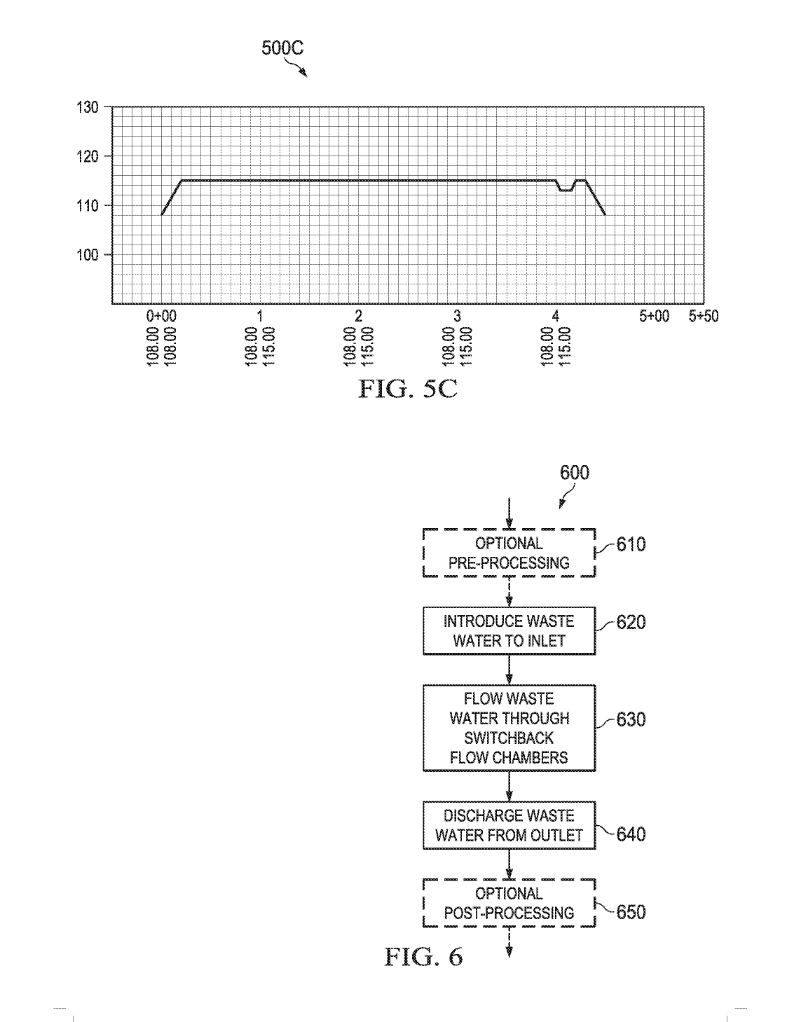

In yet another embodiment (as representatively illustrated, e.g., in FIG. 6), a method 600 of reducing suspended solid concentration in a volume of waste water includes steps of: optional pre-processing 610; introducing 620 a volume of water to an inlet; after introducing 620 the volume of water to the inlet, flowing 630 the volume of water through a plurality of flow chambers; after flowing 630 the volume of water through the plurality of flow chambers, discharging 640 the volume of water from an outlet, and after discharging 640, optional post-processing 650, wherein: the plurality of flow chambers is interposed between the inlet and the outlet; each of the plurality of flow chambers includes a flow path that is orthogonal to a predominant flow path between the inlet and the outlet; each of the plurality of flow chambers are arranged substantially parallel to each other; the plurality of flow chambers includes: a plurality of stops suitably configured (or otherwise adapted) to impede introduction of surface borne floating material to a flow chamber immediately downstream of each stop; and a plurality of weirs suitably configured (or otherwise adapted) to impede introduction of settled suspended solids to a flow chamber immediately downstream of each weir; and the volume of water has a first concentration of suspended solids upon introduction to the inlet, and the volume of water has a second concentration of suspended solids after discharge from the outlet, the second concentration of suspended solids less than the first concentration of suspended solids. The second concentration of suspended solids may be between about 1/10 to about 1/100th the first concentration of suspended solids. A third concentration of iron oxide in discharge from the outlet may be less than about 1 ppm. A fourth concentration of calcium carbonate in discharge from the outlet may be less than about 0.5 ppm. A fifth concentration of barium sulfate in discharge from the outlet may be less than about 0.1 ppm. A sixth concentration of alumina in discharge from the outlet may be less than about 0.5 ppm. A seventh concentration of strontium sulfate in discharge from the outlet may be less than about 0.1 ppm. An eighth concentration of dissolved solids in effluent from the outlet may be within a range of about ±10% of a ninth concentration of dissolved solids in influent to the inlet.

Spatially relative terms, such as “beneath,” “below,” “lower,” “above,” “upper,” and the like, may be used herein for ease of description to describe an element or feature's relationship to another element or feature as representatively illustrated in the figures. Spatially relative terms are intended to encompass different orientations of devices in use or operation in addition to the orientation depicted in the figures. Apparatuses may be otherwise oriented (e.g., rotated 90 degrees, or at other orientations) and the spatially relative descriptors used herein may likewise be interpreted accordingly.

As used herein, the terms “comprises,” “comprising,” “includes,” “including,” “has,” “having,” or any contextual variant thereof, are intended to reference a non-exclusive inclusion. For example, a process, product, article, or apparatus that comprises a list of elements is not necessarily limited to only those elements, but may include other elements not expressly listed or inherent to such process, product, article, or apparatus. Furthermore, unless expressly stated to the contrary, “or” refers to an inclusive or and not an exclusive or. That is, the term “or” as used herein is generally intended to mean “and/or” unless otherwise indicated. For example, a condition “A or B” is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural connotations for such term, unless the context clearly indicates otherwise.

As used herein, the terms “measure,” “measuring,” measurement,” “determining,” “determination,” “detecting,” “detection,” “detector,” “sensing,” “sensor,” or contextual variants thereof, refer to functions or device components that assign or otherwise provide an output value for at least one of a direct measurement, an in-direct measurement, or a computed measurement. For example, a determination or detection of an angle between two lines may comprise a direct measurement of the angle between the lines, an indirect measurement of the angle (e.g., as in the case of extending the length of two non-parallel lines outside the area of observation to predict their angle of intersection), or a computed measurement (e.g., using trigonometric functions to calculate an angle). Accordingly, “determining” the angle of intersection may be regarded as equivalent to “detecting” the angle of intersection, and a “detector” for determining the angle may be regarded as directly measuring, indirectly measuring, or computing the angle between the lines.

Although steps, operations, or computations may be presented in a specific order, this order may be changed in different embodiments. In some embodiments, to the extent multiple steps are shown as sequential in the preceding description, some combination of such steps in alternative embodiments may be performed at a same time. The sequence of operations described herein may be interrupted, suspended, or otherwise controlled by another process, such as an operating system, kernel, daemon, or the like. The routines can operate in an operating system environment or as stand-alone routines. Functions, routines, methods, steps, or operations described herein can be performed in hardware, software, firmware, or any combination thereof.

It will also be appreciated that one or more elements illustrated in the Figures may also be implemented in a more-separated or more-integrated manner, or even removed or rendered inoperable in certain cases, as may be useful in accordance with particular applications and embodiments. Additionally, any signal lines or arrows in the Figures should be considered only as representative, and therefore not limiting, unless otherwise specifically noted.

Examples or illustrations provided herein are not to be regarded in any way as restrictions on, limits to, or express definitions of any term or terms with which they are associated. Instead, these examples or illustrations are to be regarded as being described with respect to a particular embodiment and as merely illustrative. Those skilled in the art will appreciate that any term or terms with which these examples or illustrations are associated will encompass other embodiments that may or may not be given therewith or elsewhere in the specification, and all such embodiments are intended to be included within the scope of that term or terms. Language designating such non-limiting examples and illustrations includes, but is not limited to: “for example,” “for instance,” “e.g.,” “etc., “or the like,” “in a representative embodiment,” “in one embodiment,” “in another embodiment,” or “in some embodiments.” Reference throughout this specification to “one embodiment,” “an embodiment,” “a representative embodiment,” “a particular embodiment,” or “a specific embodiment,” or contextually similar terminology, means that a particular feature, structure, property, or characteristic described in connection with the described embodiment is included in at least one embodiment, but may not necessarily be present in all embodiments. Thus, respective appearances of the phrases “in one embodiment,” “in an embodiment,” or “in a specific embodiment,” or similar terminology in various places throughout the description are not necessarily referring to the same embodiment. Furthermore, particular features, structures, properties, or characteristics of any specific embodiment may be combined in any suitable manner with one or more other embodiments.

The scope of the present disclosure is not intended to be limited to the particular embodiments of any process, product, machine, article of manufacture, assembly, apparatus, means, methods, or steps herein described. As one skilled in the art will appreciate, various processes, products, machines, articles of manufacture, assemblies, apparatuses, means, methods, or steps, whether presently existing or later developed, that perform substantially the same function or achieve substantially similar results in correspondence to embodiments described herein, may be utilized according to their description herein. The appended claims are intended to include within their scope such processes, products, machines, articles of manufacture, assemblies, apparatuses, means, methods, or steps.

Benefits, other advantages, and solutions to problems have been described herein with regard to representative embodiments. However, any benefits, advantages, solutions to problems, or any component thereof that may cause any benefit, advantage, or solution to occur or to become more pronounced are not to be construed as critical, required, or essential features or components.

What is claimed is:

1. A system for removing suspended solids from waste water, the system comprising:
an inlet;
an outlet;
a predominant flow path from the inlet to the outlet;
a plurality of flow chambers interposed between the inlet and the outlet, wherein each of the plurality of flow chambers comprises a flow path that is transverse to the predominant flow path, and each of the flow chambers of the plurality of flow chambers are arranged substantially parallel to each other;
a plurality of stops disposed in one or more of the plurality of flow chambers, the plurality of stops configured to impede introduction of surface borne floating material to a flow chamber immediately downstream of each stop; and
a plurality of weirs disposed in one or more of the plurality of flow chambers, the plurality of weirs configured to impede introduction of settled suspended solids to a flow chamber immediately downstream of each weir.

2. The system of claim 1, wherein the plurality of stops comprises a plurality of oil stops.

3. The system of claim 2, wherein the plurality of stops comprises one or more debris stops.

4. The system of claim 3, wherein each of the plurality of weirs are configured to allow a top portion of flowing fluid to spill over an upper portion of respective ones of the plurality of weirs.

5. The system of claim 4, wherein the plurality of flow chambers comprises a switchback configuration.

6. The system of claim 5, wherein the switchback configuration comprises an anti-parallel flow direction as between immediately adjacent flow chambers.

7. The system of claim 6, wherein the system is configured to progressively reduce suspended solid concentration along the predominant flow path.

8. The system of claim 7, wherein each flow chamber comprises at least one of at least one stop, or a weir.

9. The system of claim 8, wherein at least one flow chamber of the plurality of flow chambers comprises a plurality of stops, and a weir.

10. The system of claim 9, wherein at least another flow chamber of the plurality of flow chambers comprises a stop and a weir, and the at least another flow chamber is downstream from the at least one flow chamber.

11. A device for removing suspended solids from waste water, the device comprising:
an inlet;
an outlet;
a plurality of flow chambers interposed between the inlet and the outlet, wherein each of the plurality of flow chambers is configured with a chamber flow path that is arranged antiparallel to a neighboring chamber flow path of an immediately adjacent flow chamber, and the plurality of flow chambers are arranged substantially parallel to each other;
a plurality of stops disposed in one or more of the plurality of flow chambers, the plurality of stops configured to at least reduce introduction of surface borne floating material to a flow chamber immediately downstream of each stop; and
a plurality of weirs disposed in one or more of the plurality of flow chambers, the plurality of weirs configured to at least reduce introduction of settled suspended solids to a flow chamber immediately downstream of each weir.

12. The device of claim 11, wherein the plurality of stops comprises a plurality of oil stops, and one or more debris stops.

13. The device of claim 11, wherein each of the plurality of weirs are configured to allow a top portion of fluid flow to spill over an upper portion of respective ones of the plurality of weirs.

14. The device of claim 11, wherein each of the plurality of flow chambers are arranged in a switchback configuration relative to immediately neighboring flow chambers.

15. The device of claim 11, wherein the device is configured to progressively reduce suspended solid concentration of a volume of waste water introduced to the inlet as the volume of waste water flows from the inlet to the outlet.

16. The device of claim 11, wherein:
each flow chamber comprises at least one of a stop or a weir;
at least one flow chamber of the plurality of flow chambers comprises a plurality of stops, and a weir; and
at least another flow chamber of the plurality of flow chambers comprises a stop and a weir, and the at least another flow chamber is downstream from the at least one flow chamber.

17. A method of reducing suspended solid concentration in a volume of waste water, the method comprising:
introducing a volume of water to an inlet;
after introducing the volume of water to the inlet, flowing the volume of water through a plurality of flow chambers; and
after flowing the volume of water through the plurality of flow chambers, discharging the volume of water from an outlet, wherein:
the plurality of flow chambers is interposed between the inlet and the outlet;
each of the plurality of flow chambers comprises a flow path that is orthogonal to a predominant flow path between the inlet and the outlet;
each of the plurality of flow chambers are arranged substantially parallel to each other;
the plurality of flow chambers comprises:
a plurality of stops configured to impede introduction of surface borne floating material to a flow chamber immediately downstream of each stop; and
a plurality of weirs configured to impede introduction of settled suspended solids to a flow chamber immediately downstream of each weir; and
the volume of water comprises a first concentration of suspended solids upon introduction to the inlet, the volume of water comprises a second concentration of suspended solids after discharge from the outlet, and the second concentration of suspended solids is less than the first concentration of suspended solids.

18. The method of claim 17, wherein the second concentration of suspended solids is between about 1/10 to about 1/100th the first concentration of suspended solids.

19. The method of claim 18, wherein at least one of:
a third concentration of iron oxide in discharge from the outlet is less than about 1 ppm;
a fourth concentration of calcium carbonate in discharge from the outlet is less than about 0.5 ppm;
a fifth concentration of barium sulfate in discharge from the outlet is less than about 0.1 ppm;
a sixth concentration of alumina in discharge from the outlet is less than about 0.5 ppm; or
a seventh concentration of strontium sulfate in discharge from the outlet is less than about 0.1 ppm.

20. The method of claim 18, wherein an eighth concentration of dissolved solids in effluent from the outlet is within a range of about ±10% of a ninth concentration of dissolved solids in influent to the inlet.
